(19) United States
(12) Patent Application Publication
(10) Pub. No.: US 2010/0092730 A1
(43) Pub. Date: Apr. 15, 2010

(54) PRESSURE-SENSITIVE ADHESIVE SHEET AND PROCESS FOR PRODUCING THE SAME

(75) Inventors: Tadahiro Tomino, Saitama (JP); Koji Tabata, Saitama (JP); Shinji Hagiwara, Saitama (JP); Toshihiro Tsutsui, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: LINTEC CORPORATION, Itabashi-ku (JP)

(21) Appl. No.: 12/519,893

(22) PCT Filed: Dec. 21, 2007
(86) PCT No.: PCT/JP2007/074649

§ 371 Date: Aug. 14, 2009

(30) Foreign Application Priority Data
Dec. 21, 2006 (JP) 2006-344704

(51) Int. Cl. C09J 7/02; B32B 3/30; B32B 37/00

(52) U.S. Cl. 428/161; 428/166; 156/292

(57) ABSTRACT

An adhesive sheet which can be produced without using a release sheet having an uneven surface form and which can prevent or remove air bubbles and blisters and a process for producing the same are provided by an adhesive sheet prepared by laminating a non-permeable adhesive layer in which both surfaces are flat on an uneven surface of a base material having concave and convex parts in which adjacent concave parts are communicated with each other at least on one surface so that the adhesive layer is brought into contact with the convex part of the base material and a process comprising laminating a release sheet provided on a release treated surface with a non-permeable adhesive layer in which both surfaces are flat and a base material having concave and convex parts in which adjacent concave parts are communicated with each other at least on one surface so that the non-permeable adhesive layer is brought into contact with the convex part of the base material.

### BACKGROUND OF THE INVENTION

The present invention relates to an adhesive sheet which can prevent or remove air bubbles and blisters and a process for producing the same.

### RELATED ART

In general, an adhesive sheet is constituted from a base material sheet, an adhesive layer formed on a surface thereof and, if necessary, a release sheet provided thereon. When a peeling layer is provided, the above release sheet is removed in use, and an adhesive layer is brought into contact with an adherend and stuck thereon.

In the above adhesive sheet, when the adhesive sheet is stuck by manual work, air bubbles are formed between an adherend and the adhesive layer, and the appearance is damaged in a certain case. Such air bubbles are liable to be produced in the case of adhesive sheets having a large sticking area such as decorative adhesive sheets, adhesive sheets for paint masking, adhesive sheets for surface protection and the like.

In order to solve defects of an adhesive sheet caused by air bubbles produced, the adhesive sheet is once peeled off and then stuck again, or a hole is provided in a part swollen by the air bubble on the adhesive sheet from a base material sheet side by means of a needle to release air from the air bubble. However, problems such as breakage of the adhesive sheet, formation of wrinkles on the surface, a reduction in the adhesive strength and the like are brought about in many cases in a method in which the adhesive sheet is stuck again. On the other hand, an appearance of the adhesive sheet is damaged in a method in which a hole is provided by means of a needle.

Resin materials such as acryl resins, ABS resins, poly carbonate resins and the like generate gases in a certain case by heating or without heating. When an adhesive sheet is stuck on an adherend comprising the above resin material, blisters (swelling) are produced on the adhesive sheet by gas generated from the adherend.

In order to solve the problems described above, proposed are adhesive sheets in which a surface of an adhesive layer is provided with an uneven form so that apertures communicated in all directions and communicated as well to an outside are formed between the adhesive layer and an adherend when the adhesive sheet is stuck on the adherend and in which air and gas are discharged from the apertures between the adhesive layer and the adherend to the outside (refer to, for example, patent documents 1 and 2) and adhesive sheets in which a channel aeration layer forming a space leading to an outside and a permeable adhesive layer comprising a cloth and the like impregnated with an adhesive are formed in order on a base material layer and in which air and gas reaches the channel aeration layer permeating through the permeable adhesive layer and are discharged from the space of the channel aeration layer to the outside (refer to, for example, a patent document 3).

However, in the case of the adhesive sheets disclosed in the patent documents 1 and 2, the uneven form on the surface of the adhesive layer is formed by transferring from a release sheet having a release-treated surface of the corresponding surface form. When the above release sheet is produced by coating a release agent on a sheet having an unevenness, the uneven surface of the sheet is buried by the release agent, or nonuniformity is liable to be caused in a thickness of the release-treated surface on the uneven surface. As a result thereof, the prescribed uneven form can not be formed on the surface of the adhesive layer, or the release strength becomes nonuniform. Also, when the above release sheet is produced by pressing a hot roll having an uneven surface onto a flat base material sheet coated with a release agent, the release agent is transferred on the hot roll to cause stain of the roll and dispersion in a thickness of the release-treated surface. Further, when coating a release agent on a release sheet having a release-treated surface of an uneven surface form, air is liable to be introduced into the uneven surface, and the prescribed uneven form can not be formed on the surface of the adhesive layer in a certain case.

On the other hand, in the case of the adhesive sheet disclosed in the patent document 3, since the permeable adhesive layer comprising a cloth and the like impregnated with an adhesive and having a permeability is used, the adhesive layer itself has a void, and the sufficiently high adhesive strength is not obtained in a certain case particularly immediately after stuck.
Patent document 1: Utility Model Registration No. 2503717
Patent document 2: Utility Model Registration No. 2587198
Patent document 3: Japanese Patent Application Laid-Open No. 323270/1999

### DISCLOSURE OF THE INVENTION

The present invention has been made under the circumstances described above, and an object thereof is to provide an adhesive sheet which can be produced without using a release sheet having an uneven surface form and can prevent or remove air bubbles and blisters and in which an appearance is not damaged and a process for producing the same.

Intensive researches repeated by the present inventors in order to achieve the object described above have resulted in finding that the object can be achieved by an adhesive sheet prepared by laminating an adhesive layer in which both surfaces are flat on an uneven surface of a base material having a surface of an uneven form. The present invention has been completed based on the above knowledge.

That is, the present invention relates to:
(1) an adhesive sheet prepared by laminating a non-permeable adhesive layer in which both surfaces are flat on an uneven surface of a base material having concave and convex parts in which adjacent concave parts are communicated with each other at least on one surface so that the non-permeable adhesive layer is brought into contact with the convex part of the base material,
(2) the adhesive sheet according to the above item (1), wherein a release sheet having a flat release treated surface is further laminated on the non-permeable adhesive layer at a side which is opposite to the side brought into contact with the base material,
(3) the adhesive sheet according to the above item (1), wherein a width of the concave part is 10 to 25000 μm; a depth of the concave part is 1 to 200 μm; a distance between the adjacent concave parts is 5 to 20000 μm; a tensile modulus of the base material is 50 to 5000 MPa; and a thickness of the non-permeable adhesive layer is 10 to 300 μm,
(4) the adhesive sheet according to the above item (1), wherein the non-permeable adhesive layer is stuck on an adherend and pressed from a base material side, whereby the non-permeable adhesive layer is adhered to an inner wall of the concave parts on a surface of the base material to make it possible to form a cavity between the non-permeable adhesive layer and the adherend,
(5) a process for producing an adhesive sheet, comprising laminating a release sheet provided on a release treated surface with a non-permeable adhesive layer in which both surfaces are flat and a base material having concave and convex parts in which adjacent concave parts are communicated with each other at least on one surface so that the non-permeable adhesive layer is brought into contact with the convex part of the base material and
(6) the process for producing an adhesive sheet according to the above item (5), wherein a width of the concave part is 10 to 25000 μm; a depth of the concave part is 1 to 200 μm; a distance of the adjacent concave parts is 5 to 20000 μm; an tensile modulus of the base material is 50 to 5000 MPa; and a thickness of the non-permeable adhesive layer is 10 to 300 μm.

The adhesive sheet of the present invention can be used by sticking on an adherend in the same manner as in conventional adhesive sheets. For example, when stuck on an adherend, the adhesive sheet is pressed from a base material side, whereby the adhesive layer is adhered onto a concave part on an uneven surface of the base material, and a cavity is formed on an adherend side. Assuming that air is introduced when the adhesive sheet is stuck or that gas is generated from the adhesive sheet after the adhesive sheet is stuck, so that air or gas is present between the adherend and the adhesive layer, the adhesive layer is pushed by the air or the gas to assist the adhesive layer to be adhered onto the concave part of the base material. The above cavity thus formed takes over an uneven surface form of the base material. The adjacent cavities are communicated with each other, and therefore air present between the adherend and the adhesive layer or gas generated from the adherend after stuck is discharged to an outside through the above cavities, whereby the inferior appearance is prevented from being caused by blisters.

An release sheet having a release-treated surface of an uneven form does not have to be used, and therefore it is possible to cut down the steps and reduce the cost, so that the adhesive sheet of the present invention can be produced without changing the existing facilities to a large extent.

### BRIEF EXPLANATION OF THE DRAWINGS

FIG. 1 is a cross-sectional drawing of the adhesive sheet of the present invention.

FIG. 2 is a cross-sectional drawing showing a state in sticking the adhesive sheet of the present invention on an adherend.

FIG. 3 is a cross-sectional drawing showing a state after sticking the adhesive sheet of the present invention on an adherend.

FIG. 4 is a cross-sectional drawing showing another state in sticking the adhesive sheet of the present invention on an adherend.

FIG. 5 is a cross-sectional drawing showing another state after sticking the adhesive sheet of the present invention on an adherend.

### EXPLANATION OF CODES

1 Adhesive sheet
2 Base material
3 Adhesive layer
4 Concave part
5 Convex part
6 Adherend
7 Air
8 Cavity

### BEST MODE FOR CARRYING OUT THE INVENTION

The adhesive sheet of the present invention shall be explained below with reference to drawings.

In the present invention, “flat” means a usual surface state formed by coating or casting without carrying out specific forming; “a release sheet having a flat release-treated surface” is a release sheet obtained by coating a release agent on a usual sheet in which a surface is not subjected to formation processing such as emboss processing and the like by a usual method; and “an adhesive layer in which both surfaces are flat” is an adhesive layer formed by coating or casting an adhesive on a release treated surface of the above release sheet by a usual method.

Also, “a non-permeable adhesive layer” is not a layer having a permeability as is the case with a cloth and the like impregnated with an adhesive, and it means a layer comprising substantially only an adhesive and having no permeability.

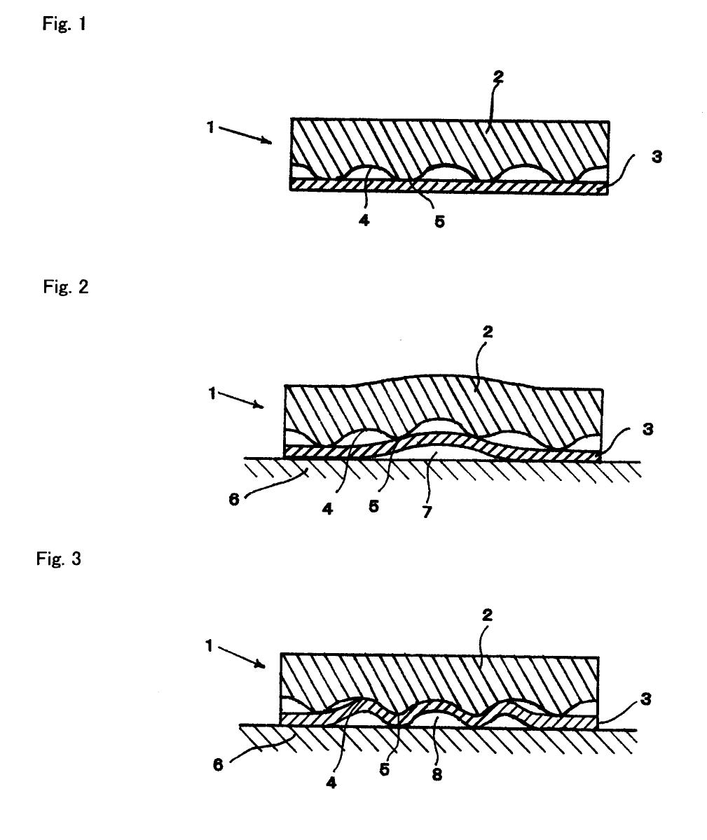

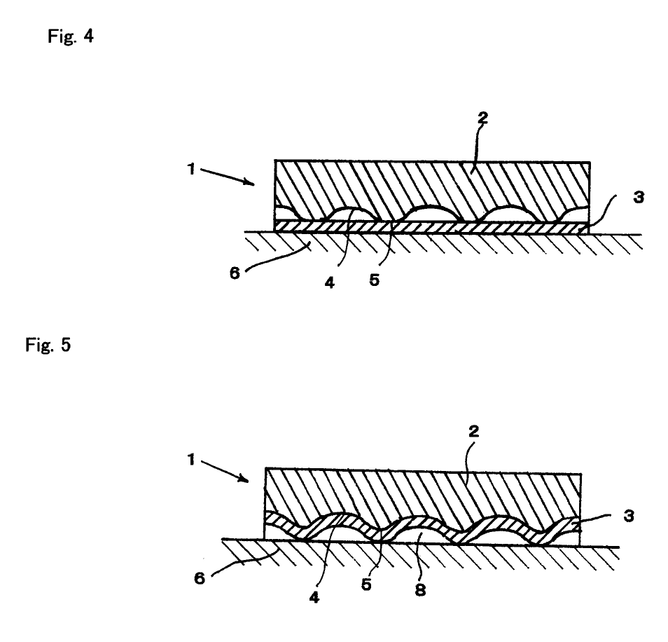

FIG. 1 is a cross-sectional drawing of the adhesive sheet of the present invention; FIG. 2 is a cross-sectional drawing showing a state in sticking the adhesive sheet of the present invention on an adherend; and FIG. 3 is a cross-sectional drawing showing a state after sticking the adhesive sheet of the present invention on an adherend. FIG. 4 is a cross-sectional drawing showing another state in sticking the adhesive sheet of the present invention on an adherend, and FIG. 5 is a cross-sectional drawing showing another state after sticking the adhesive sheet of the present invention on an adherend. As shown in FIG. 1, the adhesive sheet 1 of the present invention comprises a base material 2 and an adhesive layer 3; one surface of the base material 2 has an uneven form comprising a concave part 4 and a convex part 5; and the adhesive layer 3 in which both surfaces are flat is laminated thereon in contact with the convex part 5. Though not shown in the drawing, the adjacent concave parts 4 are communicated with each other.

As shown in FIG. 2 and FIG. 3, when air 7 is present between the adhesive layer 3 and an adherend 6 in sticking the adhesive sheet 1 of the present invention onto the adherend 6, the adhesive layer 3 is pushed out to a concave part 4 side by air 7 by sufficiently pressing the adhesive sheet 1 from a base material 2 side, and the concave part 4 is stuck onto the adhesive layer 3, so that a cavity 8 is formed at an adherend 6 side.

Also, in another constitution, when the adhesive sheet 1 of the present invention is stuck onto an adherend 6 as shown in FIG. 4 and FIG. 5, a base material 2 is deformed by sufficiently pressing the adhesive sheet 1 from a base material 2 side to push out a concave part 4 to an adhesive layer 3 side, and the concave part 4 is stuck onto the adhesive layer 3. Then, the concave part 4 is restored, whereby a cavity 8 is formed at an adherend 6 side.

Usually, an adhesive strength between an adherend and an adhesive layer is not large so much at a moment of sticking, and it reaches an ultimate adhesive strength after a time of about 24 hours passes. Accordingly, if the adhesive sheet is pressed from a base material 2 side at the same time as being stuck onto the adherend 6, the phenomenon that the adhesive layer 3 is adhered onto the concave part 4 of the base material 2 which is deformed and pushed out as described above is brought about. Further, when air 7 is present between the adherend 6 and the adhesive layer 3 as shown in FIG. 2, the adhesive layer 3 is pushed out to a direction of the base material 2 by the air 7, and it assists the adhesive layer 3 to be adhered onto the concave part 4 of the base material 2.

Since the cavity thus formed takes over an uneven form on the surface of the base material 2, the adjacent cavities are communicated with each other, and air present between the adhesive layer 3 and the adherend 6 and gas generated from the adherend after stuck move through the adherends and are discharged to an outside if the end part leads to the outside.

The base material shall not specifically be restricted, and materials suitably selected from base materials which have so far been publicly known as a base material for adhesive sheets can be used. The above base material includes, for example, resin sheets of polyolefins such as polyethylene, polypropylene, polymethylpentene and the like, polyesters such as polyethylene terephthalate, polybutylene terephthalate, polyethylene naphthalate and the like, polyvinyl chloride, polystyrene, polyurethane, polycarbonate, polyamide, polymethyl methacrylate, polybutene, polybutadiene, polymethylbenzene, ethylene-vinyl acetate copolymers, ethylene-(meth)acrylic acid copolymers, ethylene-(meth)acrylic ester copolymers, ABS resins, ionomer resins and the like, foamed sheets, metal foils, paper base materials such as woodfree papers, coated papers, impregnated papers and the like and laminated sheets comprising the above materials.

The base material has a thickness of 10 to 300 μm, particularly preferably 20 to 200 μm.

As described above, in pressing the base material in order to stick the adhesive sheet onto the adherend, the base material is deformed to push out the concave part to an adhesive layer side. In order to meet the above matter, the base material has preferably a tensile modulus of 50 to 5000 MPa, particularly preferably 200 to 3000 MPa.

In an uneven form on the surface of the base material, the adjacent concave parts have to be communicated with each other. The uneven form shall not specifically be restricted as long as it satisfies the above condition, and it may be, for example, a form in which a lot of protrusions are provided and a form in which grooves of a V-shaped type, a U-shaped type, an inverted trapezoidal type and the like are provided in a lattice form, an oblique lattice form, a plural parallel linear or curved band form or a lattice form. Further, it may be a form in which a lot of protrusions having different sizes are provided.

In an uneven form on the surface of the base material, in order to form a cavity between the non-permeable adhesive layer and the adherend, a width of the concave part is 10 to 25000 μm, particularly preferably 100 to 20000 μm and further preferably 100 to 450 μm, and a depth of the concave part is 1 to 200 μm, particularly preferably 3 to 150 μm. Also, in order to satisfy requirements on an air discharge property, a blister resistance, an appearance and an adhesive strength immediately after sticking, a distance between the adjacent concaves is 5 to 20000 μm, particularly preferably 50 to 1000 μm.

A method for providing the surface of the base material with an uneven form shall not specifically be restricted and includes a method in which an uneven form is directly provided by emboss processing using an emboss roll and other methods and a method in which a film is produced on a process sheet provided on a surface with an uneven form by a casting method.

The adhesive sheet of the present invention may be an adhesive sheet prepared by providing an adhesive layer on an uneven surface of a base material in which only one surface is an uneven surface and in which the other surface is flat, and in addition thereto, it may be an adhesive sheet of a so-called double-faced tape type prepared by laminating an adhesive layer in which both surfaces are flat on both surfaces of a base material in which both surfaces have an uneven form. In the above case, the effect of the present invention that air bubbles and blisters are prevented or removed is obtained as well.

The adhesive for forming the adhesive layer shall not specifically be restricted, and adhesives which have so far been conventionally used for an adhesive layer of an adhesive sheet, for example, acryl base adhesives, polyurethane base adhesives, polyester base adhesives, rubber base adhesives, silicone base adhesives and the like can be used.

The adhesive may be any of an emulsion type, a solution type and a solventless type, and it may be either a cross-linking type or a non-cross-linking type.

A thickness of the adhesive layer is 5 to 100 μm, particularly preferably 10 to 50 μm.

The adhesive sheet of the present invention is suitably produced by laminating a release sheet provided on a release treated surface with a non-permeable adhesive layer in which both surfaces are flat and a base material having concave and convex parts in which adjacent concave parts are communicated with each other at least on one surface so that the non-permeable adhesive layer is brought into contact with the convex part of the base material and is not substantially brought into contact with the convex part of the base material.

That is, the adhesive is first applied on the release treated surface of the release sheet having a flat release treated surface, dried and cross-linked to form an adhesive layer in which both surfaces are flat, and then the base material having concave and convex parts in which adjacent concave parts are communicated with each other at least on one surface is laminated thereon so that the non-permeable adhesive layer is brought into contact with the convex part of the base material.

In preparing an adhesive sheet of a so-called double-faced tape type as described above, an adhesive layer may be laminated on an opposite surface (a surface on which a non-permeable adhesive layer is not laminated) of the base material in the same manner.

The release sheet shall not specifically be restricted and includes usually used sheets, for example, paper base materials such as glassine paper, coated paper, woodfree paper and the like, laminated papers obtained by laminating resins such as polyethylene and the like on the above paper base materials and plastic films such as polyester films of polyethylene terephthalate, polybutylene terephthalate, polyethylene naphthalate and the like and polyolefin films of polypropylene, polyethylene and the like, which is coated with release agents. Silicone base release agents, fluorine base release agents, linear alkyl base release agents and the like can be used as the release agent. A thickness of the release sheet is preferably 10 to 400 μm, and a thickness of the release agent layer is preferably 0.03 to 1 μm.

In the adhesive sheet thus produced, the release sheet is laminated on the adhesive layer; the release sheet is peeled off and removed in use; and the exposed adhesive layer is brought into contact with an adherend and stuck thereon.

In the case of the adhesive sheet in which the adhesive layer is laminated, as described above, only on one surface of the base material, a surface on which the adhesive layer is not laminated in the base material may be subjected, if necessary, to printing, and it can be used as a decorative adhesive sheet, a coating masking adhesive sheet, a surface protecting adhesive sheet and the like.

Particularly when the beautiful appearance is required, an adhesive layer is further provided on a surface on which the adhesive layer is not laminated in the base material of the adhesive sheet in which the adhesive layer is laminated only on one surface of the base material, or a decorative adhesive sheet, a coating masking adhesive sheet, a surface protecting adhesive sheet and the like which are subjected, if necessary, to printing are laminated thereon via the adhesive layer on one surface of the adhesive sheet of a double-faced tape type, and they can be used as a decorative adhesive sheet, a coating masking adhesive sheet, a surface protecting adhesive sheet and the like for which the adhesive sheet of the present invention is used.

### Examples

Next, the present invention shall be explained in further details with reference to examples, but the present invention shall by no means be restricted by these examples.

Various evaluations for adhesive sheets obtained in the examples and the comparative examples were carried out by the following methods.

### (1) Air Bubble Disappearing Test:

The adhesive sheet cut to 50 mm×50 mm was stuck on a melamine-coated plate by manual work so that circular air bubbles having a diameter of about 15 mm were formed, and the above adhesive sheet was pressed by means of a squeegee to visually observe whether or not the air bubbles disappeared.

As the results thereof, the adhesive sheet was evaluated as ◯ when the air bubbles disappeared, and the adhesive sheet was evaluated as × when the air bubbles remained as they were.

### (2) Blister Resistance Test:

The adhesive sheet cut to 30 mm×130 mm was sufficiently pressed onto a polystyrene plate (thickness: 3 mm) of 70 mm×150 mm and a polyethylene plate (thickness: 3 mm) of 70 mm×150 mm as adherends by means of a squeegee and stuck thereon.

The test pieces thus obtained were put in a thermostatic bath of 70° C. after 5 minutes since sticking. The test pieces were take out after 3 hours since putting to confirm the presence of swelling (abnormal appearance brought about by blisters) of the adhesive sheet.

As the results thereof, the adhesive sheet in which swelling was not caused was evaluated as ◯, and the adhesive sheet in which swelling was caused was evaluated as ×.

### Example 1

Used as a base material was a polyethylene terephthalate sheet (trade name: PET 50(N) Emboss NR, manufactured by DYNIC CORPORATION) having a thickness of 50 μm and a tensile modulus of 3000 MPa, and the surface was subjected to uneven processing by forming grooves of a U-shaped type having a width of 100 μm and a depth of 25 μm in a lattice form having a pitch of 700 μm, and thereby square convex parts having a side of 600 μm were provided.

On the other hand, an acryl base adhesive (trade name: PK, manufactured by LINTEC Corporation) was coated in a thickness of 15 μm on a release treated surface of a release sheet having a flat release treated surface in which a release agent was coated on a surface, and it was heated and cross-linked to form an adhesive layer.

The release sheet in which the adhesive layer was formed was laminated on the above base material having an uneven surface so that a convex part on the surface of the base material was brought into contact with the adhesive layer, whereby an adhesive sheet was obtained.

The adhesive sheet thus obtained was subjected to the air bubble disappearing test and the blister resistance test, and the results thereof are shown in Table 1.

### Example 2

An adhesive sheet was obtained in the same manner as in Example 1, except that used as the base material was polyethylene naphthalate having a thickness of 25 μm and a tensile modulus of 2900 MPa, and the surface was subjected to uneven processing by forming grooves of a U-shaped type having a width of 400 μm and a depth of 15 μm in a lattice form having a pitch of 2400 μm, and thereby rhombic convex parts having a side of 2000 μm were provided.

The adhesive sheet thus obtained was subjected to the air bubble disappearing test and the blister resistance test, and the results thereof are shown in Table 1.

### Example 3

An adhesive sheet was obtained in the same manner as in Example 1, except that used as the base material was polyurethane having a thickness of 100 μm and a tensile modulus of 250 MPa, and the surface was subjected to uneven processing by forming grooves of a U-shaped type having a width of 450 μm and a depth of 30 μm in a lattice form having a pitch of 900 μm, and thereby square convex parts having a side of 450 μm were provided.

The adhesive sheet thus obtained was subjected to the air bubble disappearing test and the blister resistance test, and the results thereof are shown in Table 1.

### Example 4

An adhesive sheet was obtained in the same manner as in Example 1, except that used as the base material was an ethylene•vinyl acetate copolymer having a thickness of 100 μm and a tensile modulus of 210 MPa, and the surface was subjected to uneven processing by forming grooves of a U-shaped type having a width of 180 μm and a depth of 50 μm in a lattice form having a pitch of 360 μm, and thereby square convex parts having a side of 180 μm were provided.

The adhesive sheet thus obtained was subjected to the air bubble disappearing test and the blister resistance test, and the results thereof are shown in Table 1.

### Comparative Example 1

An adhesive sheet was obtained in the same manner as in Example 1, except that a usual polyethylene terephthalate sheet having a thickness of 50 μm in which a surface was not subjected to uneven processing was used as the base material.

The adhesive sheet thus obtained was subjected to the air bubble disappearing test and the blister resistance test, and the results thereof are shown in Table 1.

TABLE 1

| | Air bubble | |
|---|---|---|
| | disappearing property | Blister resistance |
| Example 1 | ◯ | ◯ |
| Example 2 | ◯ | ◯ |
| Example 3 | ◯ | ◯ |
| Example 4 | ◯ | ◯ |
| Comparative | X | X |
| Example 1 | | |

As apparent from the results shown in Table 1, in the adhesive sheets obtained in Examples 1 to 4, the air bubbles were readily removed, and the appearance was good. However, in the adhesive sheet obtained in Comparative Example 1, the air bubbles were not removed, and swelling was brought about to make the appearance inferior.

### INDUSTRIAL APPLICABILITY

The adhesive sheets of the present invention are suitable particularly as a large-sized adhesive sheet such as decorative adhesive sheets, coating masking adhesive sheets and surface protecting adhesive sheets for metal plates.

1. An adhesive sheet prepared by laminating a non-permeable adhesive layer in which both surfaces are flat on an uneven surface of a base material having concave and convex parts in which adjacent concave parts are communicated with each other at least on one surface so that the adhesive layer is brought into contact with the convex part of the base material.

2. The adhesive sheet according to claim 1, wherein a release sheet having a flat release treated surface is further laminated on the non-permeable adhesive layer at a side which is opposite to the side brought into contact with the base material.

3. The adhesive sheet according to claim 1, wherein a width of the concave part is 10 to 25000 μm; a depth of the concave part is 1 to 200 μm; a distance between the adjacent concave parts is 5 to 20000 μm; a tensile modulus of the base material is 50 to 5000 MPa; and a thickness of the non-permeable adhesive layer is 10 to 300 μm.

4. The adhesive sheet according to claim 1, wherein the non-permeable adhesive layer is stuck on an adherend and pressed from a base material side, whereby the non-permeable adhesive layer is adhered to an inner wall of the concave parts on a surface of the base material to make it possible to form a cavity between the non-permeable adhesive layer and the adherend.

5. A process for producing an adhesive sheet, comprising laminating a release sheet provided on a release treated surface with a non-permeable adhesive layer in which both surfaces are flat and a base material having concave and convex parts in which adjacent concave parts are communicated with each other at least on one surface so that the non-permeable adhesive layer is brought into contact with the convex part of the base material.

6. The process for producing an adhesive sheet according to claim 5, wherein a width of the concave part is 10 to 25000 μm; a depth of the concave part is 1 to 200 μm; a distance between the adjacent concave parts is 5 to 20000 μm; an tensile modulus of the base material is 50 to 5000 MPa; and a thickness of the non-permeable adhesive layer is 10 to 300 μm.
